(19) United States
(12) Patent Application Publication
(10) Pub. No.: US 2016/0144608 A1
(43) Pub. Date: May 26, 2016

(54) METHOD FOR TRANSFERRING DEVICE

(71) Applicant: MIKRO MESA TECHNOLOGY CO., LTD., Apia (WS)

(72) Inventor: Pei-Yu CHANG, Tainan City (TW)

(21) Appl. No.: 14/551,066

(22) Filed: Nov. 23, 2014

(51) Int. Cl. B32B 38/10; B32B 37/12

(52) U.S. Cl. CPC B32B 38/10; B32B 37/12; B32B 2309/105

(57) ABSTRACT

A method for transferring at least one device is provided. The method includes: coating a first adhesive layer onto a first carrier substrate; putting the device onto the first adhesive layer, such that the first adhesive layer temporarily adheres the device thereto; reducing adhesion force of the first adhesive layer to the device while remaining a location of the device in a controllable region on the first adhesive layer, wherein the first adhesive layer has a Young's modulus less than or equal to 30 GPa before and after the adhesion force of the first adhesive layer is reduced; and transferring the device from the first adhesive layer to a receiving substrate after the adhesion force of the first adhesive layer is reduced.

### BACKGROUND

1. Technical Field

The present disclosure relates to a method for transferring at least one device.

2. Description of Related Art

Integration and packaging issues are one of the main obstacles for the commercialization of micro devices such as radio frequency (RF) microelectromechanical systems (MEMS) microswitches, light-emitting diode (LED) display systems, and MEMS or quartz-based oscillators.

Traditional technologies for transferring of devices include transfer by wafer bonding from a transfer wafer to a receiving wafer. One such implementation is “direct printing” involving one bonding step of an array of devices from a transfer wafer to a receiving wafer, followed by removal of the transfer wafer. Another such implementation is “transfer printing” involving two bonding/de-bonding steps. In transfer printing, a transfer wafer may pick up an array of devices from a donor wafer, and then bond the array of devices to a receiving wafer, followed by removal of the transfer wafer.

### SUMMARY

In one embodiment, a method for transferring at least one device is provided. The method includes: coating a first adhesive layer onto a first carrier substrate; putting the device onto the first adhesive layer, such that the first adhesive layer temporarily adheres the device thereto; reducing adhesion force of the first adhesive layer to the device while remaining the device within a controllable region on the first adhesive layer, in which the first adhesive layer has a Young's modulus less than or equal to 30 GPa; and transferring the device from the first adhesive layer to a receiving substrate after the adhesion force of the first adhesive layer is reduced.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIGS. 1 to 6 are cross-sectional views of intermediate steps in a method for transferring at least one device according to one embodiment of this disclosure;

FIGS. 7 and 8 are cross-sectional views of intermediate steps in a method for transferring at least one device according to another embodiment of this disclosure;

FIG. 9A is a cross-sectional view of an intermediate step when a transfer head is about to contact the device in the method for transferring at least one device according to one embodiment of this disclosure;

FIG. 9B is a cross-sectional view of an intermediate step when the transfer head contacts the device in the method for transferring at least one device according to one embodiment of this disclosure;

FIG. 10A is a cross-sectional view of an intermediate step when the transfer head is about to contact the devices in the method for transferring at least one device according to one embodiment of this disclosure; and

FIG. 10B is a cross-sectional view of an intermediate step when the transfer head contacts the devices in the method for transferring at least one device according to one embodiment of this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically depicted in order to simplify the drawings.

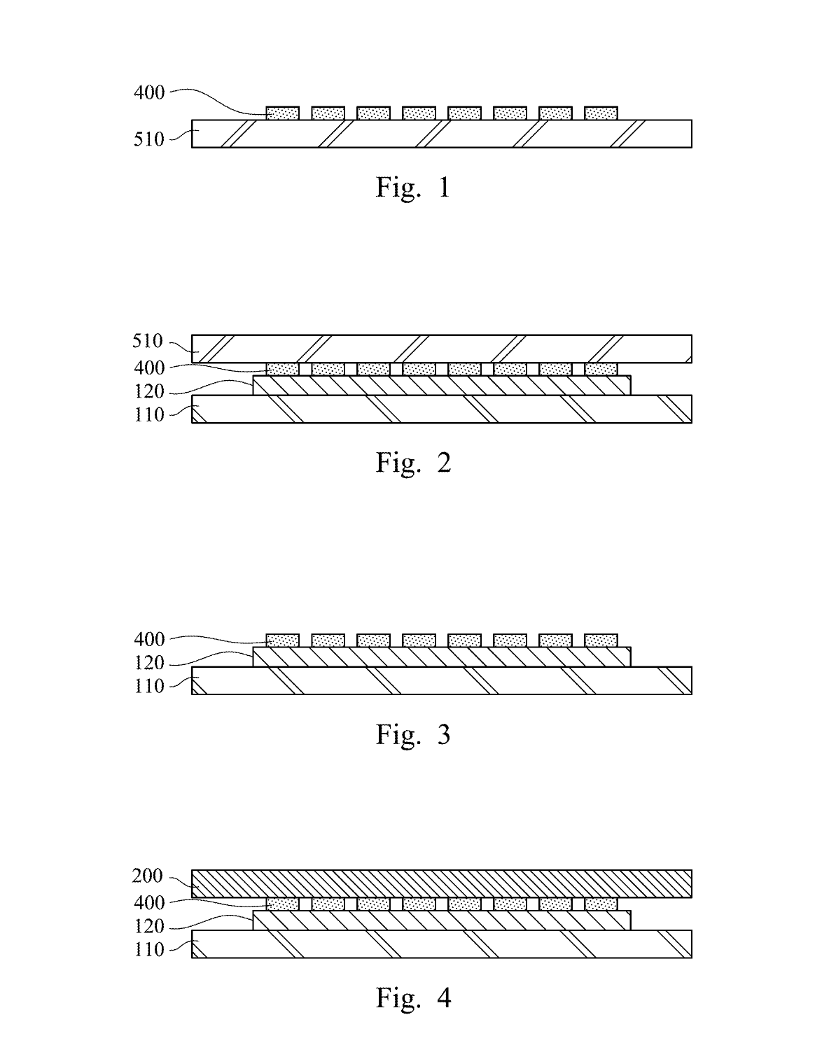

FIGS. 1 to 6 are cross-sectional views of intermediate steps in a method for transferring at least one device 400 according to one embodiment of this disclosure. A method for transferring at least one device 400 is provided. Specifically, the device 400 is a light emitting diode (LED). More specifically, the device 400 is a thin LED. The thickness of the device 400 may be in a range from about 0.5 μm to about 100 μm. The device 400 may be a cylindrical column, and the radius of the device 400 may be in a range from about 0.5 μm to about 500 μm. Embodiments of this disclosure are not limited thereto. In other embodiments, the device 400 may be a cylindrical column, a triangular prism, a cube, a cuboid, a hexagonal column, an octagonal column, or a polygon column, and the device 400 may be a chip.

As shown in FIG. 1, the devices 400 are formed on a growth substrate 510.

Then, as shown in FIG. 2, an adhesive layer 120 is coated onto a carrier substrate 110, the devices 400 with the growth substrate 510 are turned upside down and put onto the adhesive layer 120, such that the adhesive layer 120 temporarily adheres the devices 400 thereto.

Specifically, the carrier substrate 110 is a rigid substrate. More specifically, the carrier substrate 110 is made of glass, silicon, polycarbonate (PC), acrylonitrile butadiene styrene (ABS), or any combinations thereof. Embodiments of this disclosure are not limited thereto. People having ordinary skill in the art can make proper modifications to the carrier substrate 110 depending on the actual application.

Specifically, the adhesive layer 120 is made of adhesion capable organic. More specifically, the adhesive layer 120 is made of epoxy, polymethylmethacrylate (PMMA), polysiloxanes, silicone, or any combinations thereof. Embodiments of this disclosure are not limited thereto. People having ordinary skill in the art can make proper modifications to the adhesive layer 120 depending on the actual application.

The adhesive layer 120 has a thickness in a range from about 1 μm to about 100 μm. Adhesion force of the adhesive layer 120 to each of the devices 400 is in a range from about 0.01 Nt/25 mm to about 100 Nt/25 mm. The adhesive layer 120 is coated by a spin coater, a slit coater, or any combinations thereof. Embodiments of this disclosure are not limited thereto. People having ordinary skill in the art can make proper modifications to the adhesive layer 120 depending on the actual application.

As shown in FIGS. 2 and 3, the growth substrate 510 is removed from the devices 400 temporarily adhered to the adhesive layer 120. Specifically, the removing is performed by laser lift-off, chemical lift-off, or any combinations thereof. Embodiments of this disclosure are not limited thereto. The removing may be performed by other methods.

Then, the adhesion force of the adhesive layer 120 to each of the devices 400 is reduced while remaining the devices 400 respectively in a plurality of controllable regions on the adhesive layer 120. Specifically, the reduced adhesion force of the adhesive layer 120 is greater than ten times the weight of each of the devices 400, so that the devices 400 is respectively remained in the controllable regions on the adhesive layer 120.

Specifically, the adhesion force of the adhesive layer 120 is reduced by an electric field, electromagnetic radiation, heat, ultrasound, mechanical force, pressure, or any combinations thereof. Embodiments of this disclosure are not limited thereto. The reducing may be performed by other methods.

In this embodiment, the adhesion force of the adhesive layer 120 to each of the devices 400 is 20 Nt/25 mm, and the reduced adhesion force of the adhesive layer 120 to each of the devices 400 is 0.5 Nt/25 mm.

The adhesive layer 120 has a Young's modulus less than or equal to 30 GPa before and after the adhesion force of the adhesive layer 120 is reduced. Embodiments of this disclosure are not limited thereto. People having ordinary skill in the art can make proper modifications to the adhesive layer 120 depending on the actual application.

Specifically, the devices 400 are chipped devices. Embodiments of this disclosure are not limited thereto. In other embodiments, the devices 400 may be unchipped devices, and the devices 400 are chipped after the devices 400 are put on the adhesive layer 120 and before the adhesion force of the adhesive layer 120 is reduced.

More specifically, the devices 400 may be chipped linearly, such the shape of the devices is a cube, cuboid. The chipping may be performed by laser or other method. Alternatively, the devices 400 may be chipped nonlinearly, such that the shape of the devices is a pentagonal column, a hexagonal column, an octagonal column, a polygon column, or a cylindrical column. The chipping may be performed by inductively coupled plasma (ICP), wet etching, or other method. When the shape of the devices 400 is not a cuboid, the current leakage from the devices 400 is avoided. Therefore, light efficiency of the devices 400 is enhanced.

At least one process (for example, laser lift-off process or chip process) is performed on the devices 400 temporarily adhered to the adhesive layer 120 before the adhesion force of the adhesive layer 120 is reduced. Because of the adhesion force of the adhesive layer 120 to each of the devices 400, the location of each of the devices 400 is remained in a controllable region on the adhesive layer 120 during the process, or the relative locations of the devices 400 are remained in controllable regions on the adhesive layer 120 during the process. In addition, the adhesive layer 120 may function as a buffer layer to absorb external forces (for example, mechanical force).

As shown in FIG. 4, a transfer head 200 is positioned over the devices 400, and then the devices 400 are contacted with the transfer head 200. The adhesive layer 120 deforms to absorb impact force of the transfer head 200 on the devices 400 during the contacting.

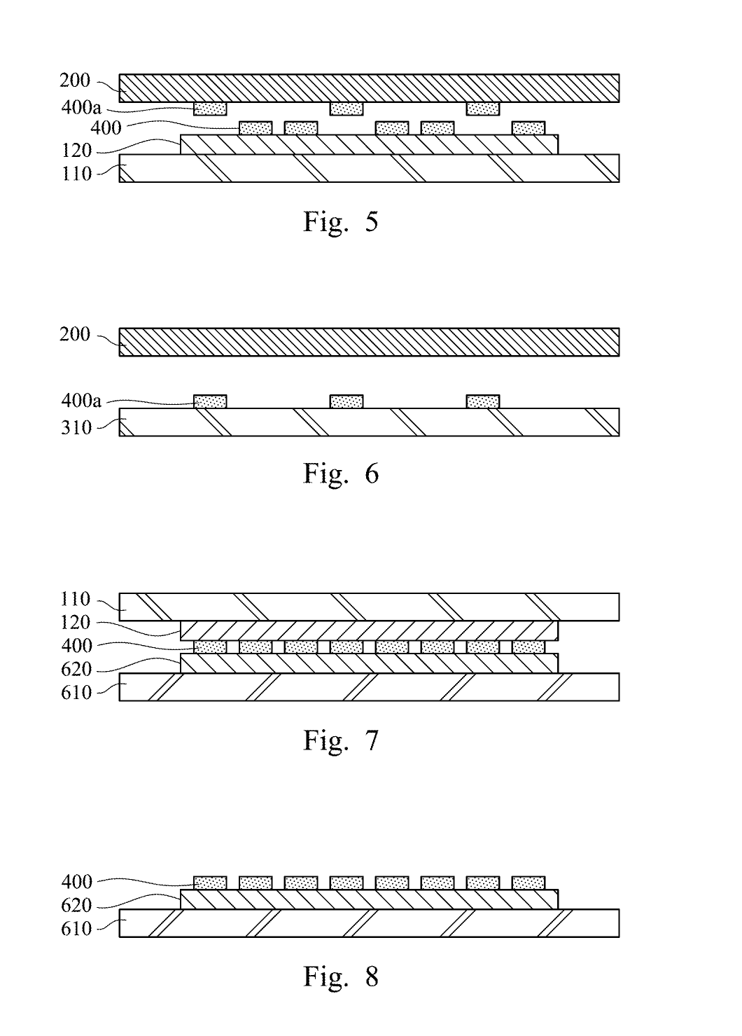

As shown in FIG. 5, the transfer head 200 is actuated to create grip force on a part of the devices 400, i.e., the devices 400a. Then, the devices 400a are picked up with the transfer head 200 from the adhesive layer 120. In the embodiment, the devices 400a are transferred to a receiving substrate. Embodiments of this disclosure are not limited thereto. In other embodiment, the devices 400a may be damaged devices, and the devices 400a are picked up and then abandoned.

Then, as shown in FIG. 6, the devices 400a are released onto a receiving substrate 310. Specifically, the devices 400a are respectively released onto specific positions of the receiving substrate 310.

The grip force of the transfer head 200 is electrostatics force, vacuum force, adhesion force, mechanical force, or any combinations thereof. Embodiments of this disclosure are not limited thereto. People having ordinary skill in the art can make proper modifications to the transfer head 200 depending on the actual application.

In this embodiment, the receiving substrate 310 is an active component array substrate. Therefore, the receiving substrate 310 and the devices 400a form a display panel. Embodiments of this disclosure are not limited thereto. In other embodiments, the receiving substrate 310 and the devices 400a may form a lighting device.

In addition, only the devices 400a (a part of the devices 400) are transferred to the receiving substrate 310. Embodiments of this disclosure are not limited thereto. In other embodiments, all of the devices 400 are transferred to the receiving substrate 310.

Because of the adhesion force and the buffer function of the adhesive layer 120, the location of each of the devices 400 temporarily adhered to the adhesive layer 120 is remained in a controllable region during processes, such that the transfer head 200 is easy to be positioned over the devices 400. In addition, the impact forces of the transfer head 200 on the devices 400 during the contacting are absorbed by the adhesive layer 120, such that the devices 400 are not damaged by the transfer head 200. Therefore, the process yield is increased.

FIGS. 7 and 8 are cross-sectional views of intermediate steps in a method for transferring at least one device 400 according to another embodiment of this disclosure. As shown in FIG. 3, if the devices 400 temporarily adhered to the adhesive layer 120 need to be turn upside down, additional operations are needed to be performed.

As shown in FIGS. 3 and 7, an adhesive layer 620 is coated onto a carrier substrate 610. Then, after the adhesion force of the adhesive layer 120 to each of the devices 400 is reduced, the adhesive layer 120 with the carrier substrate 110 is turned upside down, and the devices 400 contact the adhesive layer 620. The adhesive layers 120 and 620 deform to absorb impact forces of the adhesive layers 120 and 620 on the devices 400 during the contacting.

Then, as shown in FIG. 8, because of the adhesion force of the adhesive layer 620 to each of the devices 400, the adhesive layer 620 temporarily adheres the devices 400 thereto, and the adhesive layer 120 with the carrier substrate 110 is removed. The following operations are similar to the aforementioned operations as shown in FIGS. 4 to 6.

Specifically, the reduced adhesion force of the adhesive layer 120 is greater than the weight of each of the devices 400, such that the devices 400 do not fall from the adhesive layer 120 when the adhesive layer 120 is turned upside down or during handling process.

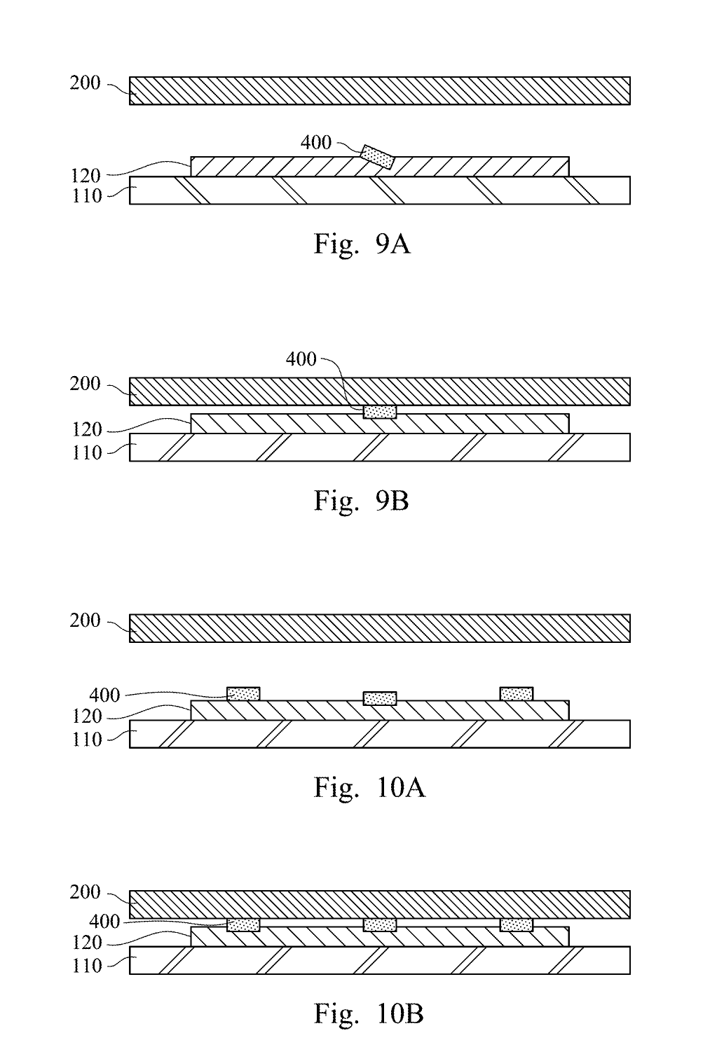

The adhesive layer 120 has alignment function as well. FIG. 9A is a cross-sectional view of an intermediate step when the transfer head 200 is about to contact the device 400 in the method for transferring at least one device 400 according to one embodiment of this disclosure. FIG. 9B is a cross-sectional view of an intermediate step when the transfer head 200 contacts the device 400 in the method for transferring at least one device according to one embodiment of this disclosure. As shown in FIG. 9A, the device 400 temporarily adhered to the adhesive layer 120 may not be level. As shown in FIG. 9B, when the transfer head 200 contacts the device 400, the adhesive layer 120 deforms and levels the device 400 with the transfer head 200, such that the device 400 is aligned with the transfer head 200 and the transfer head 200 is easy to pick up the device 400.

FIG. 10A is a cross-sectional view of an intermediate step when the transfer head 200 is about to contact the devices 400 in the method for transferring at least one device 400 according to one embodiment of this disclosure. FIG. 10B is a cross-sectional view of an intermediate step when the transfer head 200 contacts the devices 400 in the method for transferring at least one device 400 according to one embodiment of this disclosure. As shown in FIG. 10A, different devices 400 may not be disposed at the same height, such that a part of devices 400 disposed at a lower height may not be picked up by the transfer head 200 due to a gap between the part of the devices 400 and the transfer head 200. As shown in FIG. 10B, when the transfer head 200 contacts the device 400, the adhesive layer 120 deforms and levels the devices 400 with the transfer head 200 to eliminate the gap between the devices 400 and the transfer head 200 to maintain the grip force of the transfer head 200, such that the devices 400 are aligned with the transfer head 200 and the transfer head 200 is easy to pick up the devices 400.

Because of the adhesion force and the buffer function of the adhesive layer 120, the location of each of the devices 400 temporarily adhered to the adhesive layer 120 is remained in a controllable region during processes, such that the transfer head 200 is easy to be positioned over the devices 400. In addition, the impact forces of the transfer head 200 on the devices 400 during the contacting are absorbed by the adhesive layer 120, such that the devices 400 are not damaged by the transfer head 200. Therefore, the process yield is increased.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, 6th paragraph. In particular, the use of “step of” in the claims herein is not intended to invoke the provisions of 35 U.S.C. §112, 6th paragraph.

What is claimed is:

1. A method for transferring at least one device, the method comprising:
coating a first adhesive layer onto a first carrier substrate;
putting the device onto the first adhesive layer, such that the first adhesive layer temporarily adheres the device thereto;
reducing adhesion force of the first adhesive layer to the device while remaining the device within a controllable region on the first adhesive layer, wherein the first adhesive layer has a Young's modulus less than or equal to 30 GPa; and
transferring the device from the first adhesive layer to a receiving substrate after the adhesion force of the first adhesive layer is reduced.

2. The method of claim 1, further comprising:
performing at least one process on the device temporarily adhered to the first adhesive layer before the adhesion force of the first adhesive layer is reduced.

3. The method of claim 1, wherein the device is a light emitting diode (LED) with a growth substrate thereon; and
further comprising:
removing the growth substrate from the LED temporarily adhered to the first adhesive layer before the adhesion force of the first adhesive layer is reduced.

4. The method of claim 3, wherein the removing is performed by laser lift-off, chemical lift-off, or any combinations thereof.

5. The method of claim 1, wherein the device is an unchipped device; and
further comprising:
chipping the unchipped device temporarily adhered to the first adhesive layer before the adhesion force of the first adhesive layer is reduced.

6. The method of claim 5, wherein the chipping comprises:
linearly chipping the unchipped device.

7. The method of claim 5, wherein the chipping comprises:
nonlinearly chipping the unchipped device.

8. The method of claim 1, wherein the device is a chipped device.

9. The method of claim 1, wherein the transferring comprises:
positioning a transfer head over the device;
contacting the device with the transfer head, wherein the first adhesive layer deforms to absorb impact force of the transfer head on the device during the contacting;
actuating the transfer head to create grip force on the device;
picking up the device with the transfer head; and
releasing the device onto the receiving substrate.

10. The method of claim 9, wherein the grip force is electrostatics force, vacuum force, adhesion force, mechanical force, or any combinations thereof.

11. The method of claim 1, wherein the transferring comprises:
positioning a transfer head over the device;
contacting the device with the transfer head, wherein the first adhesive layer levels the device with the transfer head;
actuating the transfer head to create grip force on the device;
picking up the device with the transfer head; and
releasing the device onto the receiving substrate.

12. The method of claim 1, wherein a plurality of the devices are put onto the first adhesive layer; and
the transferring comprises:
positioning a transfer head over the devices;
contacting the devices with the transfer head, wherein the first adhesive layer levels the devices with the transfer head;
actuating the transfer head to create grip force on at least a part of the devices;
picking up the part of the devices with the transfer head; and
releasing the part of the devices onto the receiving substrate.

13. The method of claim 1, wherein a plurality of the devices are put onto the first adhesive layer;
wherein the reducing comprises:
reducing the adhesion force of the first adhesive layer to the devices while remaining the devices respectively within a plurality of the controllable regions on the first adhesive layer; and
wherein the transferring comprises:
transferring a part of the devices from the first adhesive layer to the receiving substrate.

14. The method of claim 1, wherein a plurality of the devices are put onto the first adhesive layer; and
wherein the reducing comprises:
reducing the adhesion force of the first adhesive layer to the devices while remaining the devices respectively within a plurality of the controllable regions on the first adhesive layer; and
wherein the transferring comprises:
transferring all of the devices from the first adhesive layer to the receiving substrate.

15. The method of claim 1, wherein the receiving substrate is a second carrier substrate;
further comprising:
coating a second adhesive layer onto the second carrier substrate;
wherein the transferring comprises:
transferring the device from the first adhesive layer to the second adhesive layer, such that the second adhesive layer temporarily adheres the device thereto; and
further comprising:
transferring the device from the second adhesive layer to a next receiving substrate.

16. The method of claim 1, wherein the receiving substrate is an active component array substrate.

17. The method of claim 1, wherein the first carrier substrate is a rigid substrate.

18. The method of claim 1, wherein the first carrier substrate is made of glass, silicon, polycarbonate (PC), acrylonitrile butadiene styrene (ABS), or any combinations thereof.

19. The method of claim 1, wherein the first adhesive layer has a thickness greater than or equal to about 1 μm.

20. The method of claim 1, wherein the device is an LED has a thickness less than or equal to about 100 μm.

21. The method of claim 1, wherein the device is a chip with a growth substrate thereon; and
further comprising:
removing the growth substrate from the chip temporarily adhered to the first adhesive layer before the adhesion force of the first adhesive layer is reduced.

22. The method of claim 1, wherein the first adhesive layer is made of epoxy, polymethylmethacrylate (PMMA), polysiloxanes, silicone, or any combinations thereof.

23. The method of claim 1, wherein the adhesion force of the first adhesive layer is reduced by an electric field, electromagnetic radiation, heat, ultrasound, mechanical force, pressure, or any combinations thereof.

24. The method of claim 1, wherein the first adhesive layer is coated by a spin coater, a slit coater, or any combinations thereof.

25. The method of claim 1, wherein the reduced adhesion force of the first adhesive layer is greater than the weight of the device.
